(19) United States
(12) Patent Application Publication
(10) Pub. No.: US 2010/0042324 A1
(43) Pub. Date: Feb. 18, 2010

(54) Method and apparatus using towed or autonomous marine laboratory

(76) Inventor: Robert J. Murphy, West Palm Beach, FL (US)

Correspondence Address: ROBERT W PITTS, PO BOX 11483, WINSTON-SALEM, NC, 27116-1483, US

(21) Appl. No.: 12/384,662

(22) Filed: Apr. 7, 2009

Related U.S. Application Data
(60) Provisional application No. 61/123,292, filed on Apr. 7, 2008.

(51) Int. Cl. G06F 19/00; B63H 19/00; B63B 35/00; B63B 38/00; A62C 3/10; A62C 35/00; E02B 15/06

(52) U.S. Cl. 702/2; 440/113; 114/382; 169/62; 405/63

(57) ABSTRACT

Vessels comprising towed array and an autonomous self propelled instrument array can be use to perform marine laboratory tests as well as other functions. Propulsion can be provided by diesel-electric hybrid engines, by a motion charging device and by an ocean current generator. Data can be collected by the onboard laboratory and transmitted to a central database accessible by remote users. The vessel can also be used to counter natural and man made threats in a marine environment.

### CROSS REFERENCE TO PRIOR CO-PENDING APPLICATION

This application claims the benefit of prior co-pending US Provisional Patent Application Ser. No. 61/123,292 filed Apr. 7, 2008.

### BRIEF DESCRIPTION OF THE DRAWINGS

FIG. 1 is a view of a first embodiment of a towed array or autonomous self propelled instrument array showing components employed to maneuver the vessel and sensors or components for obtaining data.

FIGS. 2A-2G are views of an autonomous vessel and sensors deployed on the vessel as well as components for propelling the vessel in a marine environment. Break lines in each view show how the views of FIGS. 2A-2G are connected to depict the complete autonomous vessel. FIGS. 2A-2E show the vessel from bow to stem and FIG. 2F and 2G shows the upper portions of the vessel.

FIG. 2H shows the relative positions of the views of FIGS. 2A-2G, with the Figure numbers 2A-2G shown in their respective portions of FIG. 2H.

FIG. 3 depicts a motion generator employed with this vessel.

FIG. 4 depicts an ocean current generator employed with this vessel.

FIG. 5 shows the components of the laboratory employed on this vessel.

FIG. 6 shows the communications and control electronics for this vessel.

### DETAILED DESCRIPTION OF THE PREFERRED EMBODIMENT

1. This new and novel device is an autonomous remote control marine laboratory at sea.

1a. Through the use of Laboratory Semiconductors, samples can be taken from the surface, sub-surface and atmosphere simultaneously. These samples will be evaluated and tested on-board the vessel and forwarded to a central database by satellite communications in real time. This data can then be accessed by licensed users of the service also in real time.

1b. There are many different laboratory Semiconductors that will be utilized to cross check the data for validity and to reduce the margin of error.

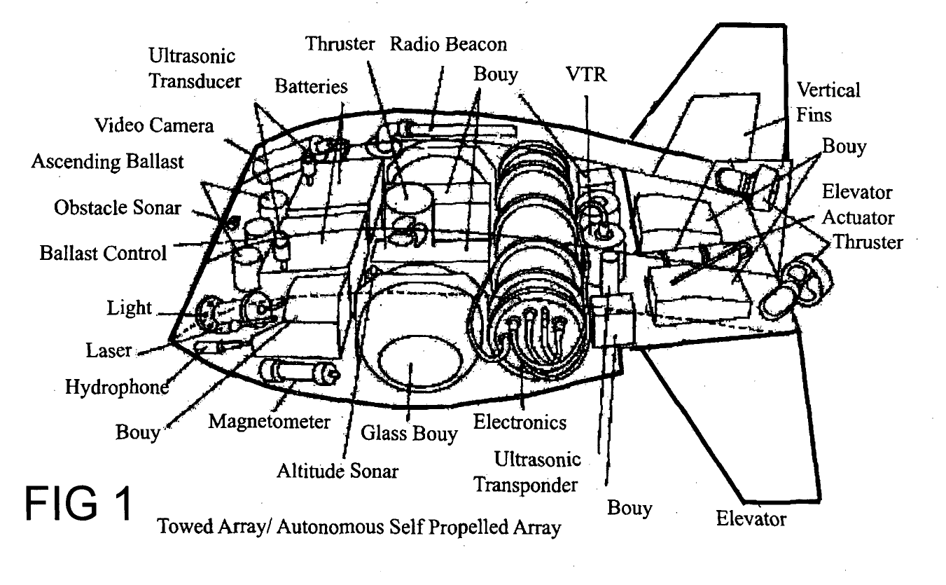

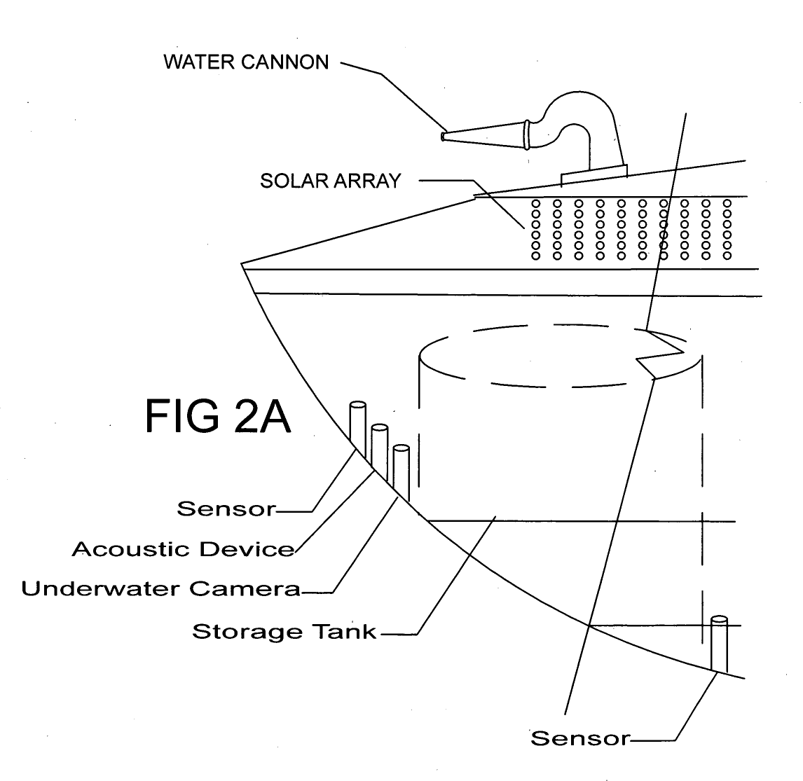

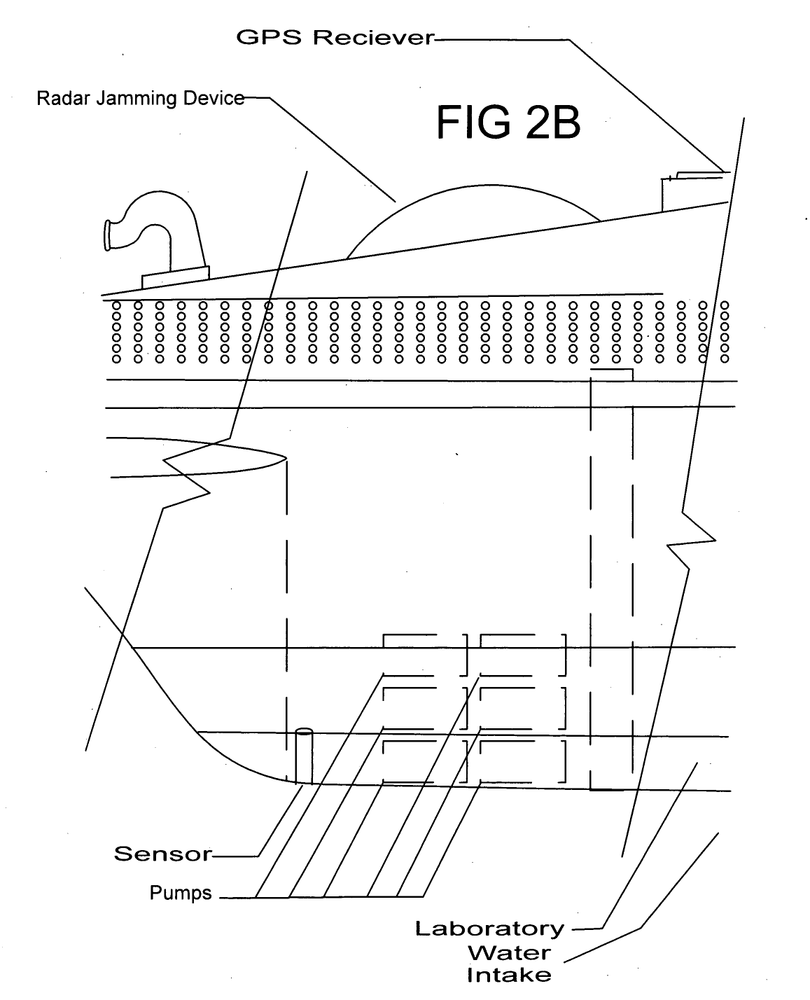

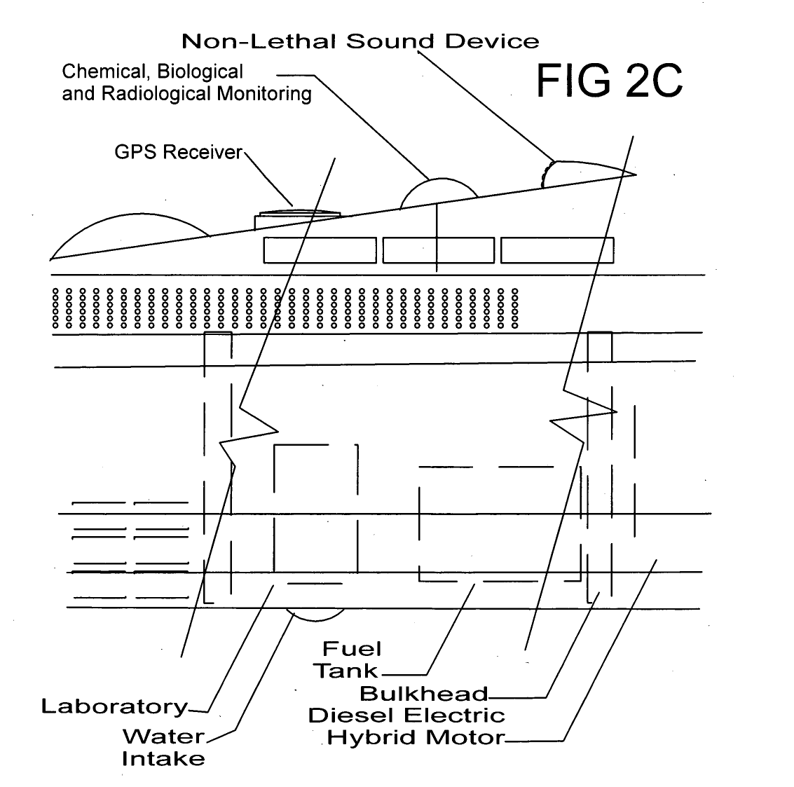

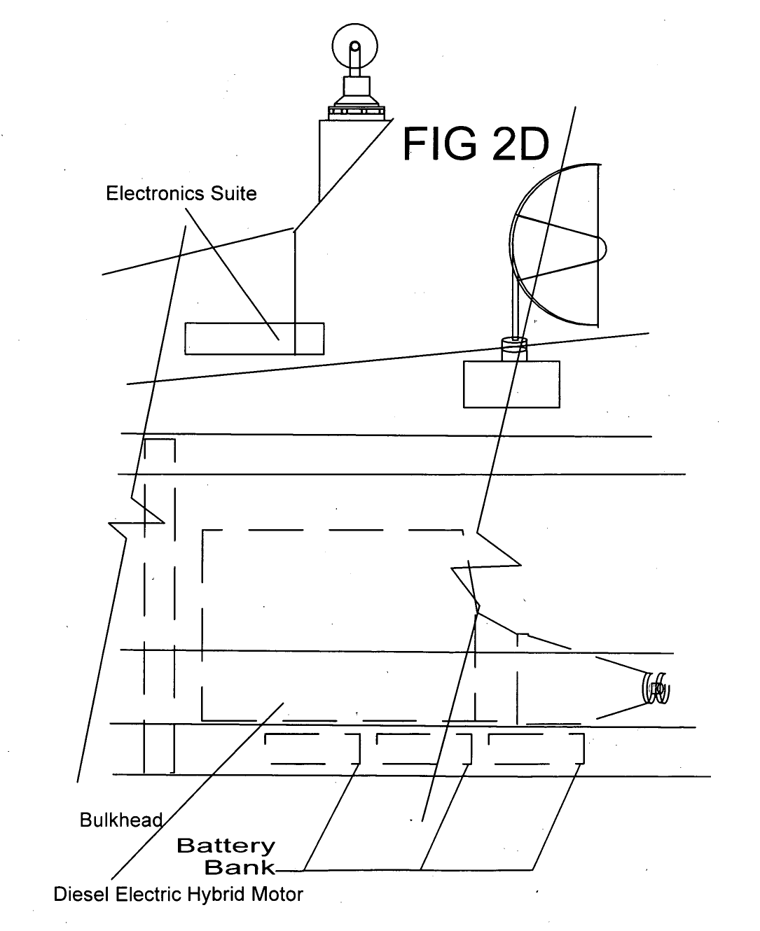

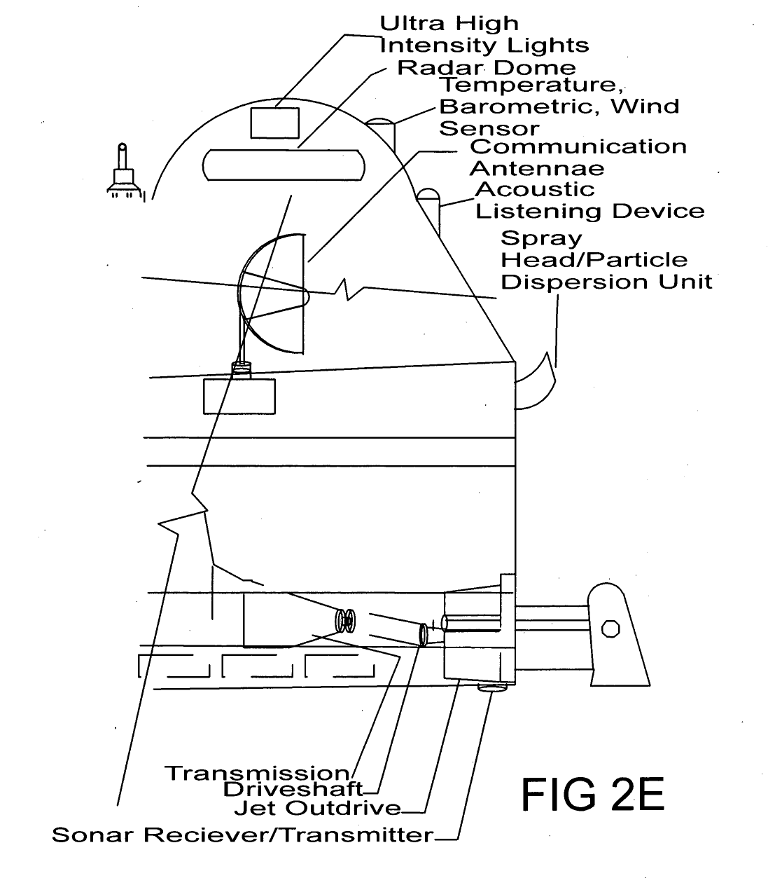

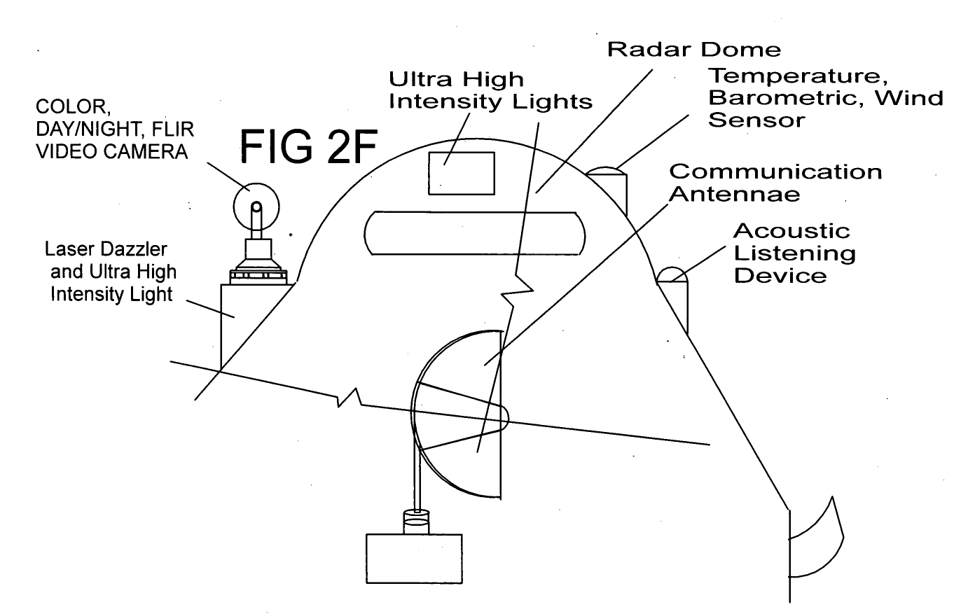

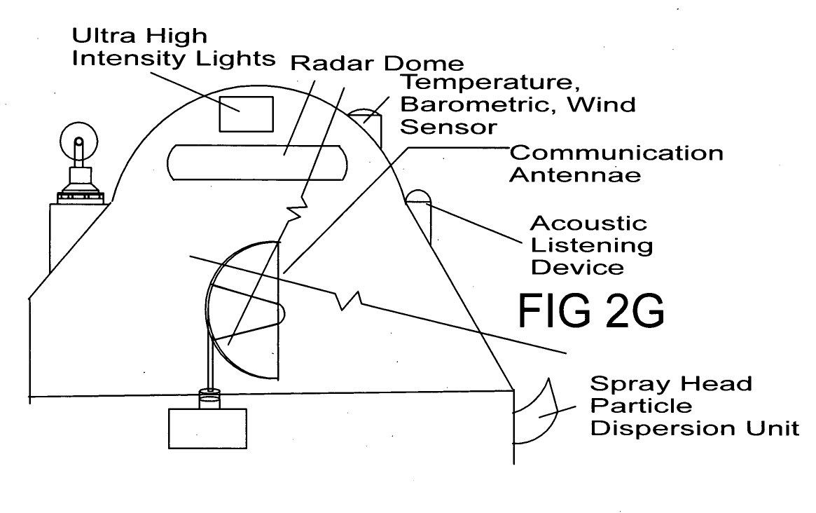

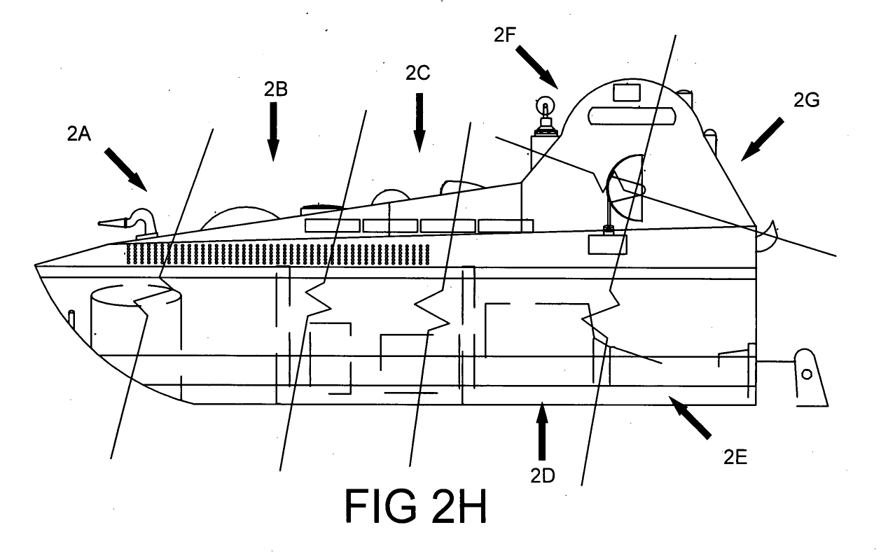

1c. The Towed Array or Autonomous Self Propelled Instrument Array, shown in FIG. 1, can be used for deep sea sampling missions and collection of sea anomalies for a number of different uses. The sample information can then be sent via umbilical cord to be uploaded to satellite and transmitted to the database. The Autonomous Self Propelled Instrument Array, shown in FIGS. 2A-2G, will perform the same type of mission capabilities, but will transmit data in packet uploads to satellite via tethered buoy or upon resurfacing.

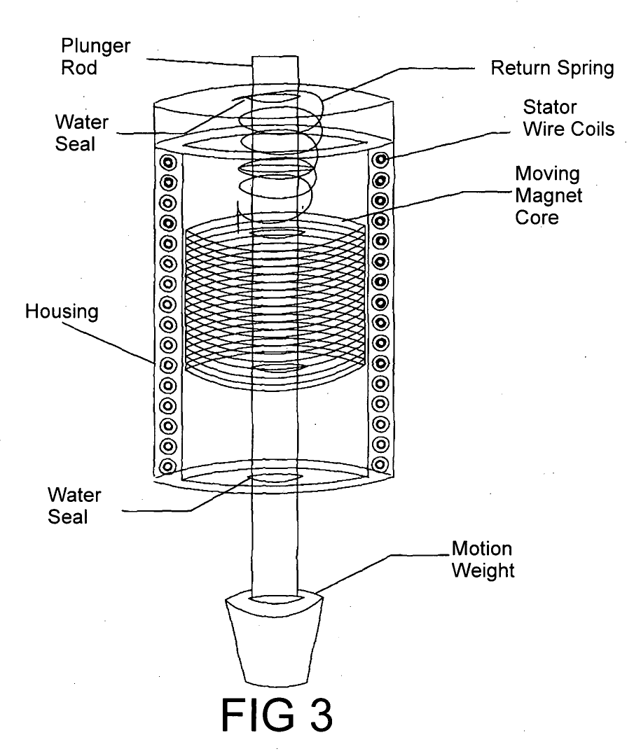

2. Novel and unique propulsion system will allow this device to loiter indefinitely at sea. Utilizing a combination of solar, multi-fuel electric hybrid engines, fuel cells, and a motion generator, shown in FIG. 3, to assist in constant charging of the on board battery banks.

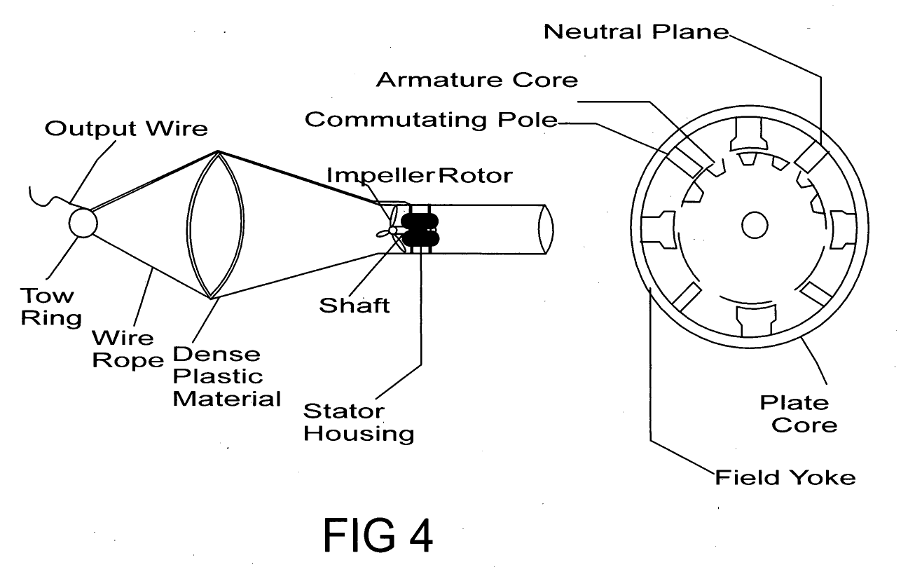

2a. Diesel-electric hybrid engines will utilize additional means to keep the batteries in a charged state, i.e. fuels cells and or solar cells to generate electricity for battery charging, hence allowing the electric hybrid to keep station and loiter for long periods without the need to refuel. Additionally a motion charging device, shown in FIG. 4, will be utilized when sea states or currents are of sufficient magnitude to generate enough motion for battery charging to occur.

3. The autonomous remote controlled laboratory can be fitted with fire fighting equipment, and it can be air lifted for rapid response.

3a. Water, foam and chemical firefighting apparatus can be employed to fight a variety of fuels and propellants on board ships at sea, maritime assets or structures on the water. This device can also be used as a non-lethal weapon to deter human threats.

4. This device may also be used to deploy booms for oil spill containment and containment chemicals. In addition it may also be used to test for contaminants in the environment.

4a. Two or more of these devices can be used to deploy oil containment booms and lasso a spill. Commercially available chemicals can also be used to contain a spill and may be recovered later by larger vessels equipped for the purpose of hazardous material recovery.

5. This device may also be used for bottom profiling and bottom sampling, undersea harvesting for pharmaceutical and scientific use. It can also be used for water surface, sub-surface and atmospheric testing for the detection of chemical, biological and radiation hazards through the use of on-board laboratory sensors that will be used to analyze the samples taken.

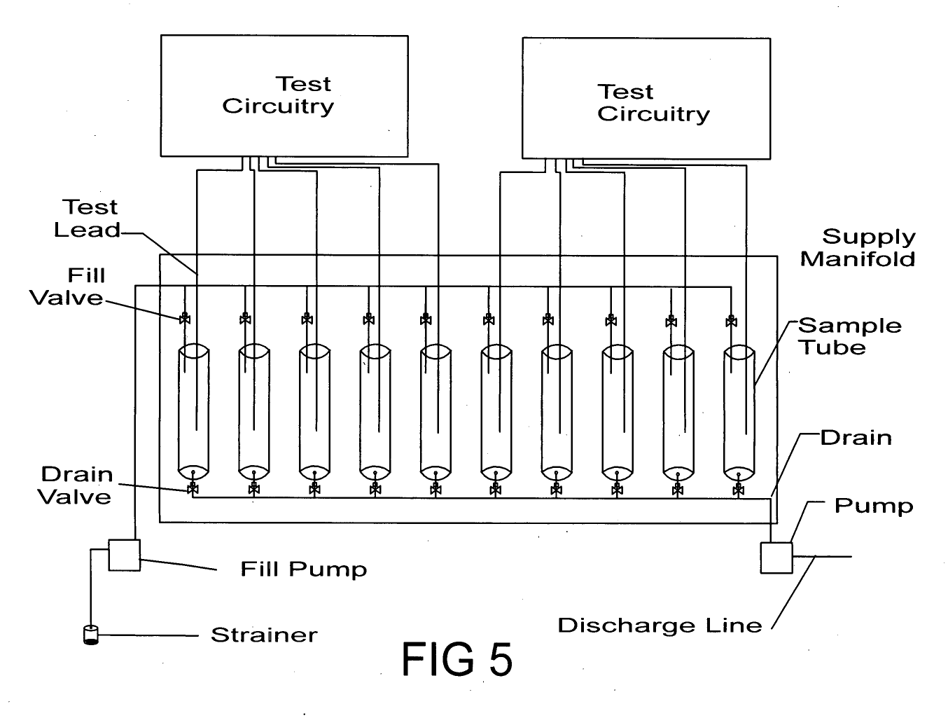

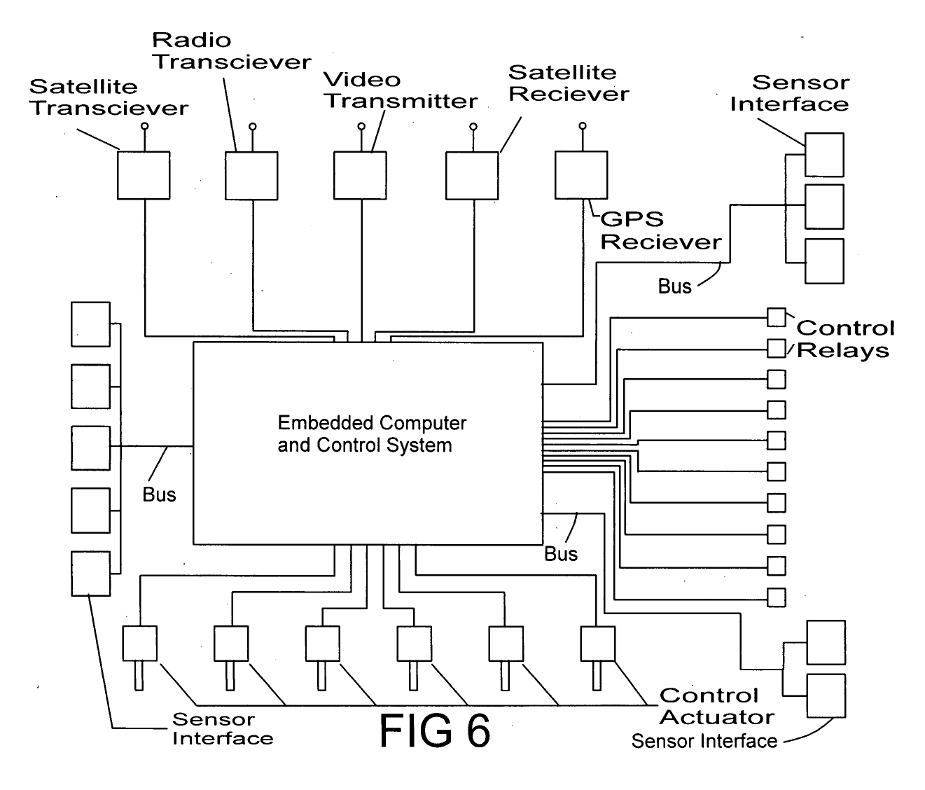

5a. This information can be evaluated onboard in an onboard laboratory, shown in FIG. 5, and the data can be uploaded to a commercial constellation of satellites and downloaded anywhere in real time to universities or other groups and institutions interested in this data.

5b. Natural phenomena, such as red tides, water current changes and temperature changes as well as seismic activity and the detection of undersea navigational hazards can be monitored by means of on-board sensing equipment or Towed Array Instruments.

6. This device may also be used for insect control measures. Insect control means can be deployed by a spraying method, aerosol method, dusting and other air deployment methods.

6a. Onboard containers using a pressurized dispersion method (spray, dusting or gaseous pesticides) will control water borne and other disease carrying pests.

7. This device may also be used to monitor animal migration through video, audio and infrared images. The habitat and the concentrations of animals within a given area, and the reproductive patterns of different species can be monitored.

8. This device may also be used to deploy smaller marine surface and subsurface craft as well as ground based and aerial unmanned vehicles. These devices may be recovered at a later time for data collection to allow the vessel to cover a large area at a given time. This device can also be used to deploy and recover scientific or military data collection devices.

9. This device may also be used for weather station operations at sea, i.e. hurricane and bathymetric readings, wind speed and direction, rainfall totals, sea ice concentrations and salinity levels. This device is impervious to weather conditions by being able to have a controlled internal environment, thus keeping instruments and samples at a stable and controlled temperature.

10. This device can be made submersible and lay dormant underwater and can be recovered by a built-in transponder. It can be made air borne at low altitude utilizing the ground effect.

10a. By using buoyancy compensation, both negative and positive this device can submerge or surface depending on its buoyancy state.

11. This device may also be used as a non-lethal threat deterrent utilizing a variety of devices. Water cannon, CS spray, sound, lights, false target imaging etc.

11a. Water cannons utilizing high pressure water jets and chemical or foam generating agents can be used to neutralize a threat at sea or on the waterfront.

11b. High volume sound devices can also be employed to render threats innocuous.

11c. Ultra high intensity lights and laser dazzlers can be used to disorient threats.

12. This device may also be used for RF and radar jamming capabilities.

12a. By outfitting the USV (unmanned surface vessel) with electronic RF and Radar jamming devices, the USV can go in at close quarters and have the same capabilities as a large vessel, but with a much smaller profile.

13. This device may be used to deploy nanoparticles for the decontamination of water i.e. arsenic absorption, Perchlorethylene absorption, etc.

14. This device may also be used to detect the deployment of toxic nanoparticles or non-toxic nanoparticles spilled or deployed into the environment by onboard testing equipment. This information can be transmitted via satellite to laboratories all over the world for further evaluation in real time.

15. The device is scalable and can be sent on intercontinental missions to do any number of scientific evaluations or other analytic water quality testing and analysis.

16. Because this device is scalable, it is able to be deployed to remote sites around the world via air deployment or shipboard deployment and is able to do a forensic evaluation of a disaster site by sending radar images, video information, audio information and analytical scientific data from the disaster site in real time via satellite communication.

17. This device in conjunction with the use of robotic arms and other devices can rescue the injured and retrieve corpses either human or other, that can then be brought in for medical examination and evaluation either forensic or for triage.

18. This device can also be used for shipping supplies i.e. medical, commercial, military re-supply missions autonomously from ship to shore or island to island as well as intercontinental missions. Offshore habitats, such as oil rigs, may be re-supplied with materials or personnel as well as emergency evacuations of an oil rig or ship in distress at sea.

19. This device can be outfitted with mine detecting apparatus and programmed to run in a grid pattern to cover a wide swath of open water. Using the Towed Array or Autonomous Self Propelled Instrument Array. The sample information can then be sent via umbilical cord to be uploaded to satellite and transmitted to the database. The Autonomous Self Propelled Instrument Array will perform the same type of mission capabilities, but will transmit data in packet uploads to satellite via tethered buoy or upon resurfacing.

Components suitable for performing these and other functions are identified in the accompanying drawings.

I claim:

1. An autonomous remote controlled marine laboratory comprising:
a vessel;
instrumentation on the vessel for taking surface, sub-surface and atmospheric samples;
means on the vessel for on-board testing of the samples; and
means on the vessel for communicating the results of on-board testing to a central database in real time

2. The autonomous remote controlled marine laboratory of claim 1 wherein the vessel is self propelled.

3. The autonomous remote controlled marine laboratory of claim 1 wherein the vessel is towed.

4. The autonomous remote controlled marine laboratory of claim 1 wherein the vessel includes fire fighting apparatus.

5. The autonomous remote controlled marine laboratory of claim 1 wherein the vessel includes means to deploy booms for oil spill containment.
